(19) United States
(12) Patent Application Publication
(10) Pub. No.: US 2025/0015656 A1
(43) Pub. Date: Jan. 9, 2025

(54) ROTOR ARRANGEMENT FOR AN ELECTRIC MACHINE AND ELECTRIC MACHINE HAVING THE ROTOR ARRANGEMENT

(71) Applicant: ZF FRIEDRICHSHAFEN AG, Friedrichshafen (DE)

(72) Inventors: Alexander MARKOW, Schweinfurt (DE); Detlef GIERLING, Röthlein (DE); Axel ROHM, Schonungen (DE); Tobias HÖCHE, Hallstadt (DE)

(21) Appl. No.: 18/711,821

(22) PCT Filed: Nov. 24, 2022
(86) PCT No.: PCT/EP2022/083078

§ 371 Date: May 20, 2024

(30) Foreign Application Priority Data
Nov. 25, 2021 (DE) 10 2021 213 253.7

(51) Int. Cl. H02K 1/32; H02K 7/00

(52) U.S. Cl. CPC H02K 1/32; H02K 7/003

(57) ABSTRACT

A rotor assembly for an electric machine, having a rotor shaft rotateable about an axis of rotation, a rotor body. The rotor shaft is arranged coaxially in a receiving opening of the rotor body and is connected to the rotor body for conjoint rotation, a plurality of spacing regions distributed around the circumference about the axis of rotation between an outer circumference of the rotor shaft and an inner circumference of the receiving opening, and contact regions, the rotor shaft and the rotor body spaced apart from one another in the spacing regions and in contact with one another in the contact regions, wherein each of the spacing regions is divided into an inlet channel and an outlet channel which are fluidically interconnected on a first axial rotor end face via a deflection region and fluidically separated from one another on a second axial rotor end face in a connection region.

### CROSS REFERENCE TO RELATED APPLICATIONS

This is a U.S. national stage of Application No. PCT/EP2022/083078 filed Nov. 24, 2022. Priority is claimed on German Application No. DE 10 2021 213 253.7 filed Nov. 25, 2021, the content of which is incorporated herein by reference.

### BACKGROUND OF THE INVENTION

### 1. Field of the Invention

The disclosure relates to a rotor arrangement and to an electric machine having the rotor arrangement.

### 2. Description of the Related Art

Rotors for electric machines, in particular for electric machines of motor vehicles, generally have a rotor shaft with a rotor core arranged on the rotor shaft. As is already known from the prior art, the rotor shaft has a polygonal shape, wherein an inner circumferential surface of the rotor core is configured to be circular so that contact regions and gap regions are alternately formed between the rotor shaft and the rotor core. The gap regions are used as cooling channels for actively cooling the rotor core.

The publication DE 10 2018 122 977 A1 discloses a shaft arrangement, comprising: a hollow shaft with an axis of rotation and a hub body which is non-positively connected to the hub body, wherein the hollow shaft, when viewed in cross section, has a circumferentially closed wall with a plurality of support portions which are distributed over the circumference and which are in abutting contact with the hub body, and spring portions which are spaced apart from an inner circumferential surface of the hub body, wherein the inner surface regions of the spring portions are located on a smaller radius about the axis of rotation than the inner surface portions of the support portions.

### SUMMARY OF THE INVENTION

An object of one aspect of the invention is a rotor arrangement of the type mentioned in the introduction characterized by an improved dissipation of heat.

One aspect of the invention is a rotor arrangement which is configured and/or suitable for an electric machine. The rotor preferably serves for providing a drive torque of the electric machine. In particular, the rotor arrangement forms the rotating part of the electric machine, in particular the rotor.

The rotor arrangement comprises a rotor shaft, which can rotate about an axis of rotation, and a rotor body. The rotor shaft can be configured as a solid shaft or as a hollow shaft. The rotor body is preferably configured as a laminated core. The laminated core is formed by a plurality of rotor laminations stacked on top of one another in the axial direction relative to the axis of rotation. In particular, the rotor body can have a plurality of permanent magnets arranged in the laminated core, or a rotor winding which is also denoted as the armature winding.

The rotor body has a central receiving opening, wherein the rotor shaft is arranged coaxially in the receiving opening and is connected to the rotor body for conjoint rotation. In particular, the rotor shaft is positively and/or non-positively connected in the circumferential direction to the rotor body, in particular by a press fit. The receiving opening is preferably configured as a cylindrical, in particular circular, opening which penetrates the rotor body in the axial direction.

The rotor arrangement has a plurality of spacing regions and contact regions distributed over the circumference in the circumferential direction about the axis of rotation between an outer circumference of the rotor shaft and an inner circumference of the receiving opening. The rotor shaft and the rotor body are spaced apart from one another in the spacing regions and in contact with one another in the contact regions. A radial gap is formed, in particular, in the spacing regions. Preferably, the rotor shaft is spaced apart from the rotor body with a continually increasing radial spacing in the spacing regions over the circumferential length, starting from the contact regions adjoining thereto in the circumferential direction. Preferably, in the spacing regions the rotor shaft has a cross-sectional path which deviates relative to the inner circumference of the receiving opening and which is, in particular, planar and/or flattened. In particular, the connection which is fixed in terms of rotation between the rotor shaft and the rotor body is implemented in the contact regions. Preferably, in the contact regions the rotor shaft is in contact with the rotor body entirely over the circumferential length or at least in some portions in a planar manner, forming a frictional contact. Preferably, in the contact regions the rotor shaft has a cross-sectional path which is complementary to the inner circumference of the receiving opening and which, in particular, is circular-cylindrical.

The contact regions and the spacing regions preferably extend in the axial direction relative to the axis of rotation over the entire axial overall length of the rotor body. The contact regions and the spacing regions are preferably arranged so as to be distributed evenly over the circumference. In particular, three of the contact regions and three of the spacing regions which are arranged alternately over the circumference are formed between the hollow shaft and the rotor element. The rotor shaft can have a polygonal cross section for forming the contact regions and the spacing regions. When viewed in cross section, the contact regions can extend in each case over an angular range of at least 5 degrees, preferably at least 30 degrees. Alternatively, or additionally, when viewed in cross section, the contact regions can extend in each case over a maximum angular range of up to 90 degrees, preferably of up to 45 degrees. When viewed in cross section, the spacing regions can extend in each case over an angular range of at least 15 degrees, preferably at least 45 degrees. Alternatively, or additionally, when viewed in cross section, the support portions can extend in each case over a maximum angular range of up to 105 degrees, preferably of up to 60 degrees.

In the context of one aspect of the invention, it is proposed that each of the spacing regions is divided into an inlet channel and an outlet channel. The inlet channel and the outlet channel are fluidically interconnected on a first axial rotor end face via a deflection region and are fluidically separated from one another on a second axial rotor end face in a connection region. In particular, the inlet channel and the outlet channel together form a cooling channel which serves for guiding and/or distributing a coolant inside the rotor arrangement. The coolant preferably serves for cooling the rotor body, in particular the inner circumference of the receiving opening. The coolant can be a cooling liquid, for example oil, water or the like.

Preferably, the coolant is supplied via the inlet channel and discharged via the outlet channel. Preferably, the inlet channel and the outlet channel extend in the same direction and/or parallel to one another. The inlet channel and/or the outlet channel preferably extend in the axial direction relative to the axis of rotation.

An advantage of one aspect of the invention is that by dividing the spacing regions into two sub-channels, the cross section of the cooling channel is reduced and its extent at the same time is lengthened, in particular doubled. This measure can increase the flow rate of the coolant into the spacing regions and the turbulence so that an improved dissipation of heat can be achieved.

In a specific implementation, it is provided that the coolant flows along the inlet channel along a flow path in the axial direction to the deflection region, is deflected in the deflection region and flows in the axially opposing direction along the outlet channel to the connection region. In particular, a dissipation of heat both on the inner circumference of the rotor body and on the outer circumference of the rotor shaft is implemented along the flow path. Preferably, a deflection of the flow path by at least or exactly 180 degrees takes place in the deflection region. In this manner, the rotor body surrounding the rotor shaft can be effectively cooled over its entire structural length.

In a further aspect, it is provided that the spacing regions are divided in each case by a sealing portion into the inlet channel and the outlet channel. In particular, starting from the connection region the sealing portions extend in the direction of the deflection region, preferably in the axial direction relative to the axis of rotation. It should be mentioned that the sealing portions are interrupted or terminate in the deflection regions in order to connect together fluidically the inlet channel and the outlet channel. The sealing portions are preferably designed in each case as a contact seal. Particularly preferably, the sealing portions are sealingly in contact over their entire extent with the rotor shaft and/or the rotor body. The sealing portions can be resiliently deformable and/or produced from a resilient material, for example elastomer, rubber or the like. In particular, the sealing portions are selectively fixed to the rotor body or the rotor shaft, wherein during assembly of the rotor shaft the inlet channel and the outlet channel are formed by the contact of the sealing portions. Thus, a rotor arrangement which is characterized by simple assembly and a cost-effective construction is proposed. The sealing portions also ensure a fluid-tight separation of the inlet and outlet channel between the connection region and the deflection region.

In a development, it is provided that the sealing portions are formed in each case by a sealing lip (lip seal) which in the axial direction seal the rotor shaft and the rotor body relative to one another between the connection region and the deflection region. In particular, the sealing lips are fixedly connected to the rotor shaft and are sealingly in contact with the inner circumference of the rotor body in the axial direction between the deflection region and the connection region. Alternatively, the sealing lips are fixedly connected to the rotor body and are sealingly in contact with the outer circumference of the rotor shaft in the axial direction between the deflection region and connection region. Thus, a sealing portion, which is characterized by a secure, in particular gap-free, seal between the inlet channel and outlet channel along the sealing portion, is proposed.

In a further aspect, it is provided that the sealing portions are selectively mounted on the rotor shaft or on the rotor body by a material connection. In particular, the sealing portions can be adhesively bonded to the rotor shaft or the rotor body. Alternatively, the sealing portions can be vulcanized onto the rotor shaft or the rotor body. Thus, a rotor arrangement which is characterized by a simple production and a secure sealing seat is proposed.

In a further specific implementation, it is provided that the inlet channels lead in each case via an inlet opening into the connection region and that the outlet channels lead in each case via an outlet opening into the connection region, wherein the inlet opening and the outlet opening are fluidically separated from one another. The inlet opening preferably serves for connecting to a feed line and/or a coolant supply. The coolant supply can be formed by a coolant pump and/or a collection container. In principle, the outlet opening serves for connecting to a return line and/or the coolant supply. Preferably, however, the outlet opening serves for forming a coolant outlet, wherein the coolant can be discharged via the coolant outlet from the rotor arrangement to at least one of the rotor end faces and/or into a motor compartment of the electric machine. Preferably, the coolant circulates along the flow path from the inlet opening to the outlet opening. Thus, a rotor arrangement which is characterized by a simple connection, in particular to a coolant supply, is proposed.

In a further aspect, it is provided that the rotor arrangement has a first shaft insert arranged on the first axial rotor end face and a second shaft insert arranged on the second axial rotor end face. The deflection region is defined in the axial direction by the first shaft insert and the connection region is defined in the axially opposing direction by the second shaft insert. In particular, the first and the second shaft insert serve for the bearing and/or connection of the rotor shaft in terms of drive technology. The first and/or the second shaft insert are connected positively and/or non-positively and/or by a material connection to the rotor shaft in the circumferential direction. For example, the first and the second shaft insert are configured in each case as a shaft journal. In particular, at least one of the rotor shaft inserts can be coupled to a transmission shaft or a gear wheel in terms of drive technology. In principle, the first and/or the second shaft insert can be configured as separate components or individual parts. Alternatively, however, the first and/or the second shaft insert can also be connected in one piece, in particular from a common material portion, to the rotor shaft. Thus, a rotor arrangement which is characterized by a compact construction is proposed.

In a development, it is provided that the second shaft insert has a central feed channel and a plurality of radial connecting channels, wherein the feed channel is fluidically connected to the inlet channels via the connecting channels. In particular, a coolant is supplied and distributed via the second shaft insert. Preferably, the coolant flows via the feed channel into the second shaft insert and is then distributed via the individual connecting channels and conducted to the individual inlet channels. In particular, the feed channel is preferably fluidically connected to the coolant supply via at least one feed line. The feed channel is preferably configured as a coaxial bore relative to the axis of rotation. The connecting channels are preferably configured in each case relative to the axis of rotation as radial bores which all terminate in the feed channel. In particular, the feed line can be sealed in the feed channel via at least one rotary seal, wherein the feed line remains stationary during a rotation of the rotor shaft. Thus, a rotor arrangement, which is characterized by a coolant connection which is particularly compact and simple to implement in terms of production technology via the second shaft insert, is proposed. Moreover, by the integration of the feed channel and the connecting channels in the second shaft insert, this can be additionally cooled therewith.

In a further aspect, it is provided that at least the second shaft insert has a radially outwardly oriented flange, wherein a circumferential spin-off chamber is formed axially between the flange and the rotor body. In particular, during a rotation of the rotor arrangement a coolant exiting from the outlet opening is spun off in the spin-off chamber due to centrifugal forces. The coolant can be conducted inside the spin-off chamber outwardly in the axial direction, in particular in the direction of the stator. In particular, the flange for forming the spin-off chamber is arranged spaced apart from the rotor body in the axial direction. The spin-off chamber is preferably configured as an annular space which circulates around the main axis and which is open radially outwardly. The flange can be configured as a separate flange component, in particular as an annular disk, which is mounted on an outer circumference of the second shaft insert. Alternatively, however, the flange and the second shaft insert can also be produced from a common material portion and/or can be connected together in one piece. In this manner, the coolant can be discharged via the outlet openings from the rotor and preferably spun off in a targeted manner in the direction of the stator. Thus, in addition to the cooling of the rotor, a cooling of the stator, in particular the end windings, can also be made possible.

In a specific development, it is provided that the rotor arrangement has a spin-off ring which is arranged on the second axial rotor end face and which defines the inlet and the outlet channels in the radial direction in the connection region. In particular, the spin-off ring is arranged in the spin-off chamber and/or between the rotor body and the flange of the second shaft insert in the axial direction relative to the axis of rotation. Preferably, the spin-off ring is arranged coaxially and/or concentrically to the second shaft insert. In particular, the spin-off ring delimits or defines together with the second shaft insert the connection region. To this end, the spin-off ring is arranged radially spaced apart at the location of the inlet and outlet channels and/or between the inlet and/or outlet openings is radially in contact with the second shaft insert, in order to separate fluidically the inlet and outlet openings from one another.

In a further specific aspect, it is provided that the spin-off ring has a plurality of spin-off openings, wherein in each case one of the spin-off openings is fluidically connected to each outlet channel. During a rotation of the rotor arrangement, the coolant is conveyed outwardly in the radial direction via the spin-off opening, in particular into the spin-off chamber. In particular, the spin-off openings are configured as radial bores, through-passages or the like.

The spin-off openings are uniformly distributed and/or spaced apart from one another in the circumferential direction. In particular, the spin-off ring can have a plurality of spin-off openings for each outlet opening in order to achieve a more uniform distribution of the coolant. A uniform distribution of the coolant in the motor compartment can be implemented by the spin-off ring, in order to improve the cooling of the electric machine further.

In a further aspect, it is provided that the spin-off openings lead into the spin-off chamber. In particular, the coolant outlet is formed by the spin-off openings, wherein the coolant inside the spin-off chamber is distributed and conducted radially outwardly, in particular along the rotor end face. As a result, the rotor end face can be cooled over a large area to the end windings of the stator, whereby a particularly efficient cooling of the electric machine is implemented.

In a structural development, it is provided that the spin-off ring has a plurality of radially inwardly oriented support portions, wherein the spin-off ring is radially supported in each case via a support portion respectively on one of the sealing portions. In particular, the spin-off ring is centered via the support portions on the rotor shaft. The spin-off ring can be supported positively and/or non-positively on the sealing portions in the radial and/or axial direction and/or in the circumferential direction. The support portions can have in each case a receiving contour for positively receiving the sealing portion. In particular, the rotor shaft extends together with the sealing portions in the axial direction toward the second axial rotor end face in some portions, in particular in the region of the spin-off ring, beyond the rotor body, so that the spin-off ring can be positioned on the end face of the rotor shaft. Thus, a spin-off ring which is characterized by a secure seat on the rotor shaft, in particular during a rotation, is proposed.

In a further aspect, it is provided that the spin-off ring has a plurality of deflection channels in the circumferential direction, wherein the outlet channels are fluidically connected respectively to one spin-off opening in the circumferential direction respectively via one deflection channel. In particular, the flow path downstream of the outlet opening in the circumferential direction is deflected into the deflection channels and then runs in the radial direction via the spin-off openings into the spin-off chamber. The deflection channels are formed in the circumferential direction between the support portions and/or are defined by the support portions. Preferably, the deflection portions in the axial direction are defined, on the one hand, by the rotor end face and, on the other hand, by the flange. Therefore, the rotor end face can be additionally cooled by the deflection channels, whereby the cooling of the electric machine is further improved.

A aspect of the invention relates to an electric machine comprising the rotor arrangement, as already described above. Preferably, the electric machine is configured and/or suitable for driving the vehicle. In particular, the electric machine has a stator, wherein the rotor is arranged or can rotate inside the stator. Preferably, the electric machine is configured as a so-called internal rotor.

### BRIEF DESCRIPTION OF THE DRAWINGS

Further features, advantages and effects of the invention are found in the following description of preferred exemplary embodiments of the invention. In the drawings:

FIG. 1 is a partial sectional view of a rotor arrangement for an electric machine;

FIG. 2 is the rotor arrangement of FIG. 1 in a cross section;

FIG. 3 is the rotor arrangement of FIG. 1 in a further cross section;

FIG. 4 is the rotor arrangement of FIG. 1 in a longitudinal section;

FIG. 5 is the rotor arrangement of FIG. 1 in a further longitudinal section;

FIG. 6 is the rotor arrangement of FIG. 1 in a further longitudinal section; and

FIG. 7 is an electric machine with the rotor arrangement of FIG. 1 in a schematic sectional view.

### DETAILED DESCRIPTION OF THE PRESENTLY PREFERRED EMBODIMENTS

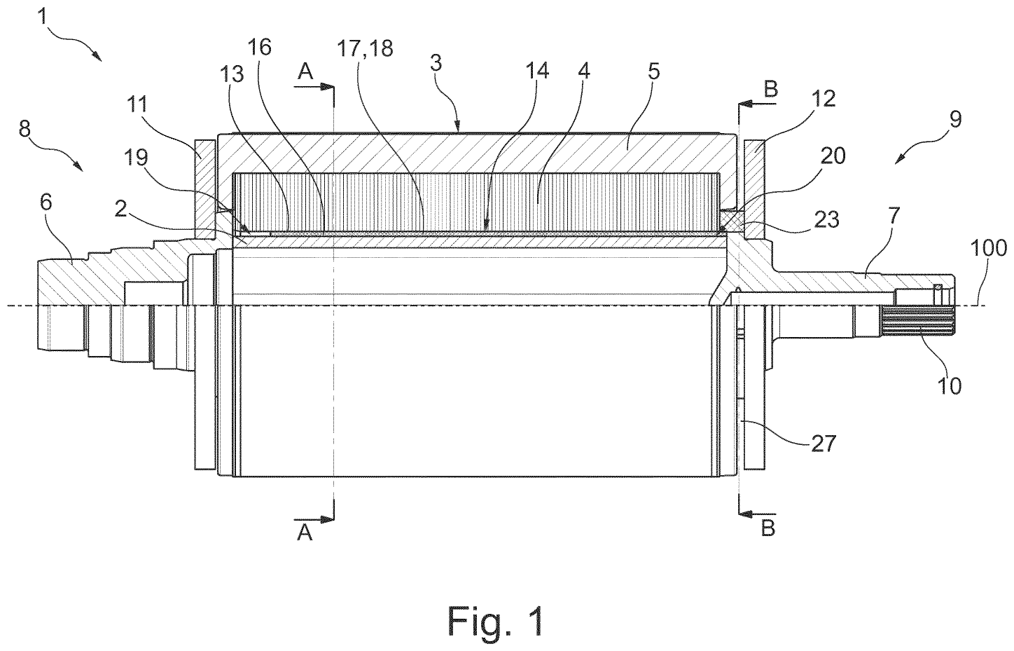

FIG. 1 shows a rotor arrangement 1 in an axial partial longitudinal section along an axis of rotation 100 as an exemplary aspect of the invention. The rotor arrangement 1 has a rotor shaft 2 and a rotor body 3 which relative to the axis of rotation 100 are arranged coaxially to one another and are connected fixedly in terms of rotation to one another. The rotor shaft 2 and the rotor body 3 are connected together fixedly in terms of rotation, for example, via a press fit. The rotor shaft 2 is configured as hollow shaft.

The rotor body 3 has a laminated core 4 with a plurality of rotor laminations stacked on top of one another in the axial direction relative to the axis of rotation 100. The rotor body 3 also has a casing 5 which surrounds the laminated core 4 in the circumferential direction and encompasses the laminated core at least in some portions in the axial direction.

The rotor arrangement 1 also has a first and a second shaft insert 6, 7, wherein the first shaft insert 6 is arranged on a first rotor end face 8 and the second shaft insert 7 is arranged on a second rotor end face 9 of the rotor body 3. The two shaft inserts 6, 7 are connected fixedly in terms of rotation to the rotor shaft 2. The first and the second shaft insert 6, 7, for example, are welded to an end face of the rotor shaft 2. The two shaft inserts 6, 7 are configured in each case as a shaft journal and serve in each case for the rotatable bearing of the rotor shaft 2. The second shaft insert 7 also has a toothing 10, for example a spline, on the end face for providing a torque.

The rotor arrangement 1 also has a first and a second flange 11, 12, wherein the first flange 11 is arranged on the first shaft insert 6 and the second flange 12 is arranged on the second shaft insert 7. The two flanges 11, 12 extend in each case relative to the axis of rotation 100 in a radial plane, wherein the rotor body 3 is arranged positively between the two flanges 11, 12 in the axial direction. For example, the two flanges 11, 12 are configured in each case as an annular disk which is arranged coaxially to the respective associated shaft insert 6, 7.

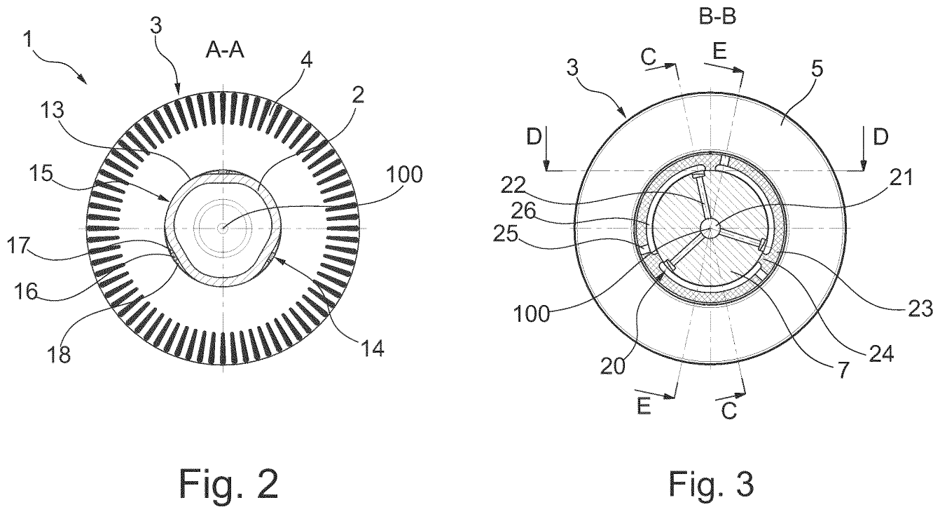

FIG. 2 shows the section A-A of FIG. 1 through the rotor arrangement 1. The rotor body 3 or the laminated core 4 has a receiving opening 13 which serves for receiving the rotor shaft 2. The receiving opening 13 is configured as a cylindrical bore which penetrates the laminated core 4 coaxially to the axis of rotation 100.

When viewed in the circumferential direction, three spacing regions 14 and three contact regions 15 which are alternately distributed over the circumference are formed between the rotor shaft 2 and the rotor body 3. In the spacing regions 14, the rotor shaft 2 is arranged spaced apart with a radial spacing from an inner circumference of the receiving opening 13 and in the contact regions 15 is in contact with the inner circumference of the receiving opening 13. A gap channel running in the axial direction to the axis of rotation 100, which serves for guiding a coolant for actively cooling the rotor laminated core, is formed in the spacing regions 14. Thus, three of the gap channels, which are separated from one another in the circumferential direction via the contact regions 15, are arranged so as to be distributed over the circumference.

In the contact regions 15 the rotor shaft is supported non-positively, in particular via the press fit, on the rotor body 3, so that the rotor body 3 can rotate jointly with the rotor shaft 2 about the axis of rotation 100. To this end, the rotor shaft 2 has a substantially polygonal shape and the receiving opening 13 has a circular shape, wherein the bulged regions of the rotor shaft 2 form the contact regions 15 and the flattened regions of the rotor shaft 2 form the spacing regions 14.

The spacing regions 14 are divided in the circumferential direction, in each case by a sealing portion 16, into an inlet channel 17 and an outlet channel 18. The sealing portions 16 are configured in each case as a sealing lip which is arranged axially along the flattened rotor shaft region and which is connected by a material connection to the rotor shaft 2, and in the axial direction is sealingly in contact with the inner circumference of the receiving opening 13. For example, the sealing portion 16 can be vulcanized onto the rotor shaft 2.

As shown in FIG. 1, the inlet channel 17 and the outlet channel 18 can be fluidically connected together on the first rotor end face 8 via a deflection region 19, and fluidically separated from one another on the second rotor end face 9 in a connection region 20. The coolant thus flows inside the spacing regions 14 from the second rotor end face 9 along the axial extent of the inlet channel 17 to the first rotor end face 8 and via the deflection region 19 along the axial extent of the outlet channel 18 back to the second rotor end face 9. The coolant enters via the inlet channel 17 into the spacing regions 14 and exits via the outlet channels 18 out of the spacing regions 14.

By the division of the spacing regions 14 into two sub-channels, the cross section of the cooling channel is reduced and its extent is at the same time lengthened, in particular doubled. This measure increases the flow rate and the turbulence of the coolant inside the spacing regions 14, whereby an improved dissipation of heat is made possible. The proposed solution, therefore, provides an optimized cooling of the rotor body 3 with a polygonal rotor shaft 2.

FIG. 3 shows the section B-B of FIG. 1 through the rotor arrangement 1. The second shaft insert 7 has a central feed channel 21 and a plurality of radial connecting channels 22 for the coolant supply, wherein the feed channel 21 is fluidically connected to the inlet channels 17 via one respective connecting channel 22. The feed channel 21 serves for connecting to a coolant supply, wherein the coolant is divided into the individual spacing regions 14 via the connecting channels 22.

The rotor arrangement 1 also has, axially adjoining the laminated core 4, a spin-off ring 23 which, as shown in in FIG. 1, is radially supported on an external circumference of the second shaft insert 7 and is positively arranged in the axial direction between the rotor body 3, in particular the laminated core 4 and the flange 12, in the region of the connecting channels 22.

The spin-off ring 23 has three radially inwardly protruding support portions 24 which are distributed in the circumferential direction and via which the spin-off ring 23 is radially supported on the sealing portions 16 and the second shaft insert 7. For example, the support portions 24 have in each case a receiving contour, not shown, which serves for positively receiving the respective sealing portion 16. To this end, the rotor shaft 2 on the second rotor end face 9 protrudes in the axial direction in some portions beyond the laminated core 4, as shown in FIG. 1, so that the spin-off ring 23 can be axially positioned on the front end of the rotor shaft 2.

The connection region 20 is formed radially between the spin-off ring 23 and the second shaft insert 7, wherein the inlet channels 17 and the outlet channels 18 in the connection region 20 are fluidically separated from one another in the circumferential direction in each case by one of the support portions 24. The connecting channels 22 lead into the connection region 20 on the side or opposite one respective inlet channel 17.

The spin-off ring 23 has in each case a spin-off opening 25 and a deflection channel 26 for each outlet channel 18, wherein the outlet channels 18 are fluidically connected in each case via a deflection portion 26 to the associated spin-off opening 25. The spin-off openings 25 are formed as radial through-passages or bores which in each case lead into a common spin-off chamber 27 as shown in FIG. 1. For forming the deflection channels 26, the spin-off ring is arranged in the radial direction between the support portions 24, spaced apart via an annular gap from the second shaft insert 7, wherein the deflection channels 26 are thus formed in the circumferential direction in each case between two adjacent support portions 24. In the axial direction, the deflection channels 26 are defined by the rotor body 4 and the second flange 12.

The spin-off chamber 27 is formed as an annular space which circulates around the axis of rotation 100 and which is formed in the axial direction between the rotor body 3 and the second flange 12. The spin-off chamber 27 is open in the radial direction, wherein due to the rotor rotation the coolant is spun off in the radial direction via the spin-off openings 25 into the spin-off chamber 27 and conducted radially outwardly.

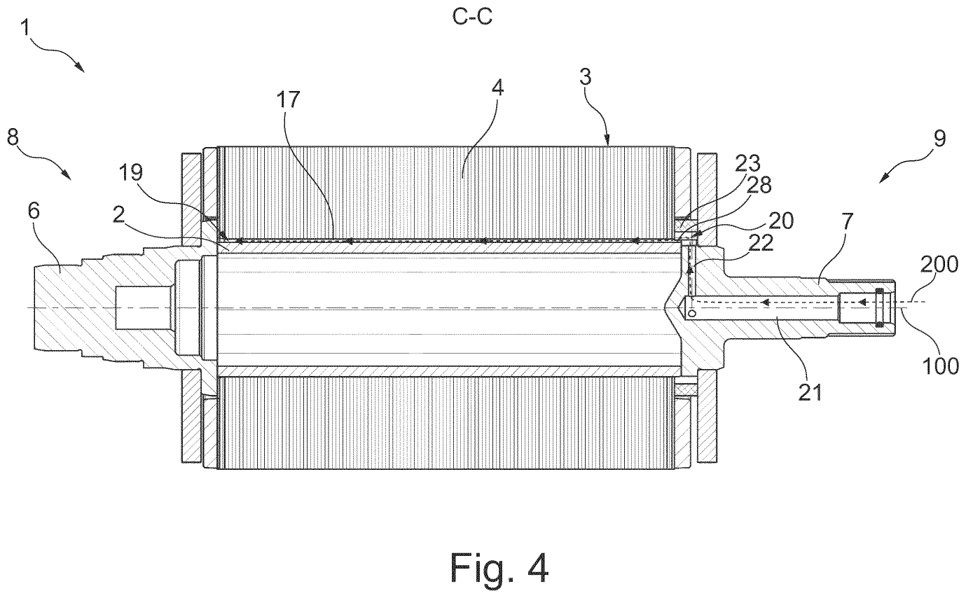

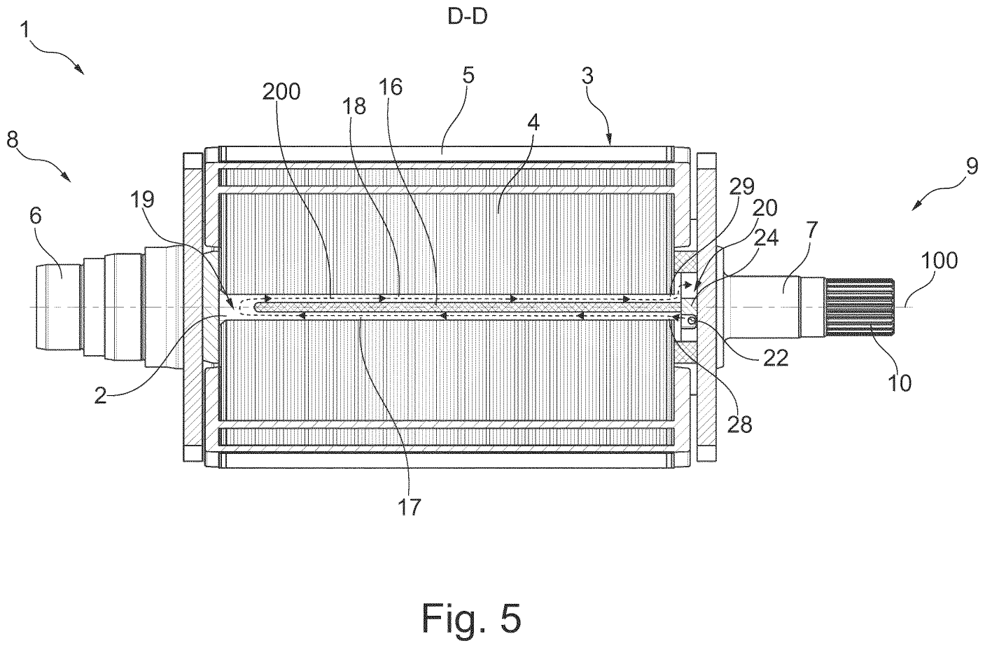

A flow path of the coolant is to be described by way of FIGS. 4 to 6, which are described together hereinafter. FIG. 4 shows the section C-C of FIG. 3, FIG. 5 the section D-D and FIG. 5 the section E-E.

As shown in FIG. 4, the feed channel 21 is configured as a bore which runs coaxially to the axis of rotation 100 and which is incorporated in the second shaft insert 7 on the end face. The connecting channels 22 are configured as radial bores which are incorporated radially in the second shaft insert 7 and terminate in the feed channel 21. The connecting channels 22 and the inlet channels 17 lead in each case together into the connection region 20 and are fluidically connected together thereby.

Thus, a flow path 200 coming from the feed channel 21 runs via the individual connecting channels 22 into the connection region 20, wherein the flow path 200 runs from the connection region 20 in each case via an inlet channel 18 in the direction of the deflection region 19.

As shown in FIG. 5, the deflection region 19 is defined in the axial direction by the first shaft insert 6 and the connection region 20 is defined in the axial direction by the second shaft insert 7. The sealing portion 16 terminates in the deflection region 19, so that the inlet channel 17 is connected via the deflection region 19 to the outlet channel 18. The inlet channels 17 lead in each case via an inlet opening 28 and the outlet channels 18 lead in each case via an outlet opening 29 into the connection region 20, wherein the inlet openings 28 and the outlet openings 29 are fluidically separated from one another in each case by one of the support portions 24 of the spin-off ring 23.

Thus, the flow path 200 runs from the inlet opening 28 along the respective inlet channel 17 in the direction of the deflection region 19, wherein the flow path 200 is deflected in the deflection region 19 by 180 degrees. Then the flow path 200 runs parallel to the inlet channel 18 in the axial direction along the respective outlet channel 18 back into the connection region 20 via the outlet opening 29.

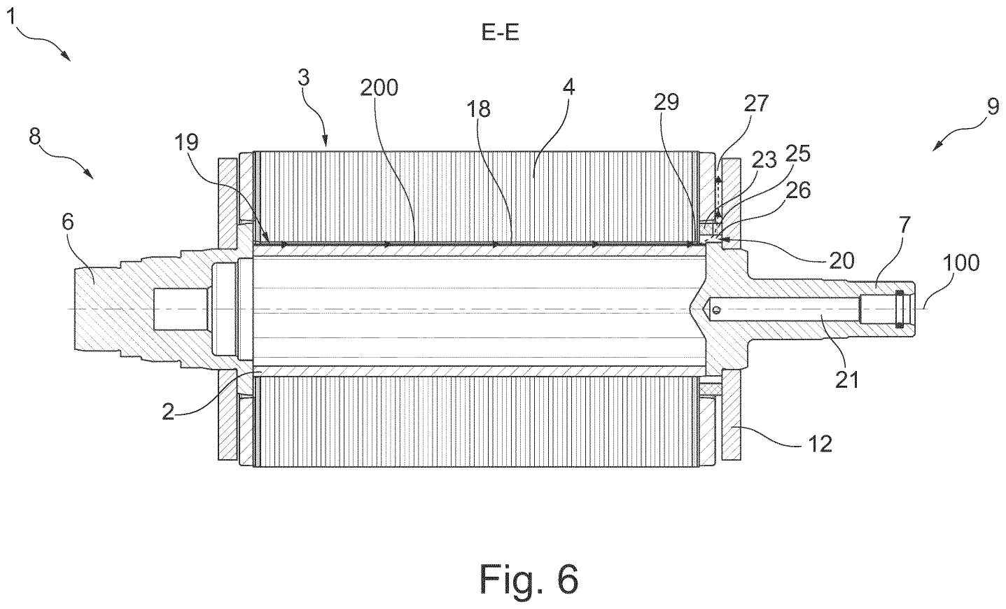

As shown in FIG. 6, the connection region 20 is defined radially by the spin-off ring 23, wherein the outlet channels 18 are connected in each case to the spin-off openings 25 via the deflection channels 26.

Thus, the flow path 200 runs from the deflection region 19 along the respective outlet channel 18 in the direction of the connection region 20 and is deflected in the deflection channel 26 in the direction of the associated spin-off opening 25. Via the spin-off openings 25, the flow path 200 runs into the spin-off chamber 27 in which the coolant is distributed and is conducted radially outwardly along the rotor body 4. For example, the coolant spun off into the spin-off chamber 27 can be returned or collected into a sump and/or spun off in a targeted manner relative to further components to be cooled.

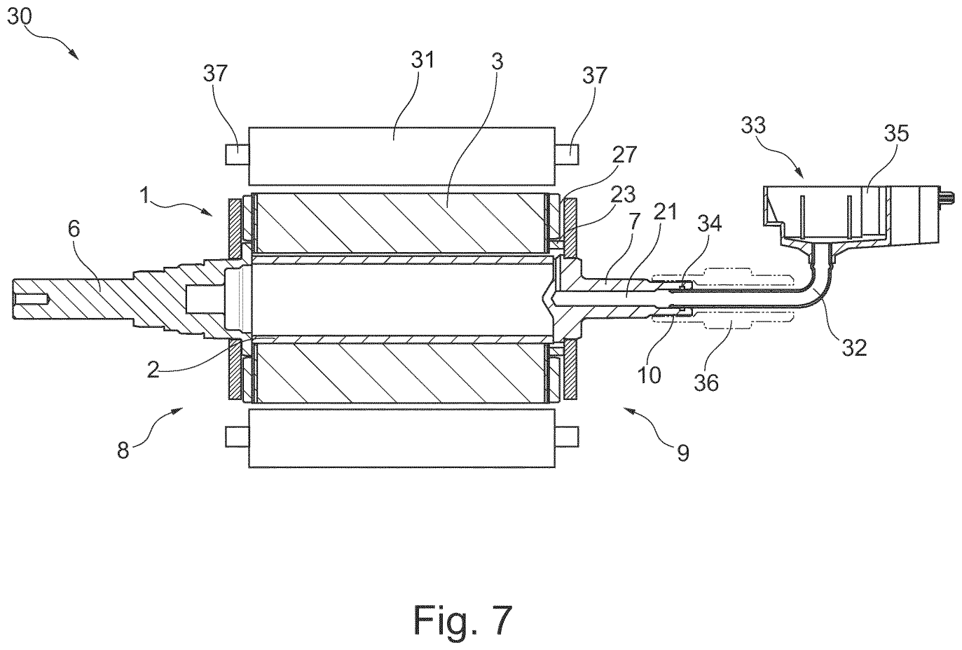

FIG. 7 shows in a schematic sectional view an electric machine 30 as a further aspect of the invention. The electric machine 30 has a stator 31 which surrounds the rotor body 3. The electric machine 30 is configured as an internal rotor, wherein the rotor arrangement 1 is arranged radially inside the stator 31 and can rotate relative thereto about the axis of rotation 100.

The second shaft insert 7 is connected to a coolant supply 33 via a feed line 32. The feed line 32 is fluidically connected to the feed channel 21 at the one end via a rotary seal 34, wherein the feed line 32 remains stationary during a rotation of the rotor shaft 2. On the other end, the feed line 32 is connected to a collection container 35 in which the coolant spun off into the motor compartment is collected and supplied back to the rotor arrangement 1.

The feed line 32 is guided coaxially through a transmission input shaft 36 of a transmission, not shown, wherein the transmission input shaft 36 is connected fixedly in terms of rotation to the second shaft insert 7 via the toothing 10. The electric machine 30 can provide a drive torque which can be transmitted via the transmission input shaft 36 to one or more drive wheels, for example for driving a vehicle.

The stator 31 has a stator winding which is formed over the end faces of the stator 31 to form protruding end windings 37. On the second axial rotor end face 9, the end winding 37 is arranged radially opposing the spin-off chamber 27. With a rotation of the rotor arrangement 1, the coolant can be spun off via the spin-off openings 25 configured in the spin-off ring 23, as described in FIG. 6, into the spin-off chamber 27 and sprayed in the radial direction against the end winding 37 arranged on the second rotor end face 9 in order to cool the end winding.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A rotor arrangement for an electric machine, comprising:
a rotor shaft, configured to rotate about an axis of rotation;
a rotor body, wherein the rotor shaft is arranged coaxially in a receiving opening of the rotor body and is connected to the rotor body for conjoint rotation;
a plurality of spacing regions and contact regions distributed over a circumference in a circumferential direction about the axis of rotation between an outer circumference of the rotor shaft and an inner circumference of the receiving opening,
wherein the rotor shaft and the rotor body are spaced apart from one another in the plurality of spacing regions and in contact with one another in the contact regions,
wherein each of the plurality of spacing regions is divided into an inlet channel and an outlet channel;
a deflection region that fluidically interconnects the inlet channel and the outlet channel on a first axial rotor end face; and
a connection region that fluidically separates the inlet channel and the outlet channel on a second axial rotor end face.

17. The rotor arrangement as claimed in claim 16, wherein a coolant flows via the inlet channel along a flow path in an axial direction relative to the axis of rotation to the deflection region, and is deflected in the deflection region and flows in an axially opposing direction via the outlet channel to the connection region.

18. The rotor arrangement as claimed in claim 16, wherein the plurality of spacing regions are divided in each case by a sealing portion running axially relative to the axis of rotation into the inlet channel and the outlet channel.

19. The rotor arrangement as claimed in claim 18, wherein the sealing portion is formed by a sealing lip which in an axial direction is sealingly in contact with the rotor shaft and/or the rotor body.

20. The rotor arrangement as claimed in claim 19, wherein the sealing portions are selectively mounted on the rotor shaft or on the rotor body by a material connection.

21. The rotor arrangement as claimed in claim 16, wherein the inlet channels for connecting to a coolant supply lead in each case via an inlet opening in the connection region and the outlet channels lead in each case via an outlet opening into the connection region for forming a coolant outlet.

22. The rotor arrangement as claimed in claim 16,
wherein a first shaft insert arranged on the first axial rotor end face and a second shaft insert arranged on the second axial rotor end face,
wherein the deflection region is defined in the axial direction by the first shaft insert and the connection region is defined in an axial opposing direction by the second shaft insert.

23. The rotor arrangement as claimed in claim 22, wherein the second shaft insert has a central feed channel and a plurality of radial connecting channels, wherein the feed channel is fluidically connected to the inlet channels via the connecting channels.

24. The rotor arrangement as claimed in claim 23, wherein at least the second shaft insert has a radially outwardly oriented flange, wherein a circumferential spin-off chamber is formed axially between the flange and the rotor body.

25. The rotor arrangement as claimed in claim 24, further comprising:
a spin-off ring which is arranged on the second axial rotor end face,
wherein the connection region is defined in a radial direction by the spin-off ring.

26. The rotor arrangement as claimed in claim 25, wherein the spin-off ring has a plurality of radial spin-off openings, wherein in each case one of the spin-off openings is fluidically connected to each outlet channel.

27. The rotor arrangement as claimed in claim 26, wherein the spin-off openings lead into the spin-off chamber.

28. The rotor arrangement as claimed in claim 27, wherein the spin-off ring has a plurality of radially inwardly oriented support portions, wherein the spin-off ring is radially supported in each case via a support portion respectively at least on one sealing portion.

29. The rotor arrangement as claimed in claim 28,
wherein the spin-off ring has a plurality of deflection channels in the circumferential direction,
wherein the outlet channels are fluidically connected respectively to one of the spin-off openings in the circumferential direction respectively via one of the deflection channels.

30. An electric machine comprising:
a rotor arrangement comprising:
a rotor shaft, configured to rotate about an axis of rotation;
a rotor body, wherein the rotor shaft is arranged coaxially in a receiving opening of the rotor body and is connected to the rotor body for conjoint rotation;
a plurality of spacing regions and contact regions distributed over a circumference in a circumferential direction about the axis of rotation between an outer circumference of the rotor shaft and an inner circumference of the receiving opening,
wherein the rotor shaft and the rotor body are spaced apart from one another in the plurality of spacing regions and in contact with one another in the contact regions,
wherein each of the plurality of spacing regions is divided into an inlet channel and an outlet channel;
a deflection region that fluidically interconnects the inlet channel and the outlet channel on a first axial rotor end face; and
a connection region that fluidically separates the inlet channel and the outlet channel on a second axial rotor end face.
